(19) United States
(12) Patent Application Publication
(10) Pub. No.: US 2010/0047047 A1
(43) Pub. Date: Feb. 25, 2010

(54) REFUSE TRUCK HAVING DOUBLE BARREL STORAGE AND METHODS

(76) Inventors: Timothy G. Mayer, Metamora, IL (US); Joseph L. Schmidt, Tonica, IL (US)

Correspondence Address: MERCHANT & GOULD PC, P.O. BOX 2903, MINNEAPOLIS, MN, 55402-0903, US

(21) Appl. No.: 12/196,052

(22) Filed: Aug. 21, 2008

(51) Int. Cl. B65F 3/00

(52) U.S. Cl. 414/539; 414/812

(57) ABSTRACT

The present disclosure is directed to a mobile refuse vehicle and related methods. The mobile refuse vehicle includes first and second storage tanks, a refuse collector, and a vacuum pressure source. The first storage tank includes a first inlet and a first outlet. The second storage tank includes a second inlet and a second outlet. The refuse collector is operably connected in fluid communication with the first and second storage tanks via the first and second inlets. The vacuum pressure source is operably connected to the first and second storage tanks to selectively provide a vacuum pressure condition in the first storage tank or the second storage tank to fill the first or second storage tank with refuse through an inlet thereof using the refuse collector while refuse is being emptied from the other of the first or second storage tank through an outlet thereof.

### FIELD OF THE DISCLOSURE

The present disclosure relates to mobile refuse vehicles generally. Mobile refuse vehicles typically include a refuse storage tank and capabilities to collect refuse into the refuse storage tank. The disclosure relates to equipment and methods for improving mobile refuse vehicle operation.

### BACKGROUND

The present disclosure relates to mobile refuse vehicles. Non-limiting examples of mobile refuse vehicles may include, among other things, street sweepers and hydro excavators. In general, mobile refuse vehicles comprise equipment having a refuse storage tank for storage of collected refuse. Refuse is typically collected by equipment of the mobile refuse vehicle that draws the refuse into the refuse storage tank. Some mobile refuse vehicles include capabilities to process the collected refuse. A variety of mobile refuse vehicles are known, including Vac-Con and those sold under the trade name Vactor and Guzzler, subsidiaries of Federal Signal Corporation.

A schematic depiction with example mobile refuse vehicle 1 is provided in FIGS. 6-7. The particular mobile refuse vehicle schematically depicted in FIGS. 6-7, is a 2100 Series—6×4 PD mobile refuse vehicle, available from Vactor, a Federal Signal Corporation. Referring to FIGS. 6-7, reference numeral 1 generally designates the mobile refuse vehicle. The mobile refuse vehicle 1 comprises, among other things, a truck 2 having a refuse storage tank 3, a refuse collector 4, and a refuse collector power source 5 mounted thereon. The refuse storage tank 3 has a minimum dump height H1 measured to a bottom side 6 at a rear end 7 of the refuse storage tank 3. The refuse storage tank 3 also has a tank height H2 measured to a central axis C of the refuse storage tank 3. Road regulations require mobile refuse vehicles to be sized within a cross-section of 102 inches wide (W) by 162 inches tall (H).

In general, the refuse storage tank 3 is filled with refuse collected by the refuse collector 4 and the refuse collector power source 5. Refuse can be collected in the refuse storage tank 3 under a vacuum pressure condition that exists in the tank 3, or by pumping refuse into tank 3. Refuse can be removed from the refuse storage tank 3 through an outlet 18 positioned near the bottom side 6.

The present disclosure relates to improvements in mobile refuse vehicles of the type generally involving a capabilities to collect and store refuse.

### SUMMARY

One aspect relates to a mobile refuse vehicle that includes first and second storage tanks, a refuse collector, and a vacuum pressure source. The refuse collector is operably connected in fluid communication with the first and second storage tanks. The vacuum pressure source is operably connected to the first and second storage tanks to selectively provide a vacuum pressure condition in at least one of the storage tanks to fill one storage tank with refuse using the refuse collector. The other storage tank can be emptied while filling of the other storage tank.

Another aspect relates to methods of operating a mobile refuse vehicle to collect and processes refuse. The mobile refuse vehicle includes first and second storage tanks. The method can include filling the first storage tank in a fill mode while the second storage tank is being emptied in a processing mode.

### BRIEF DESCRIPTION OF THE DRAWINGS

FIG. 1 is a schematic side view of an example mobile refuse vehicle in accordance with the principals of the present disclosure.

FIG. 2 is a schematic rear view of the mobile refuse vehicle shown in FIG. 1.

FIG. 3 is a schematic top view of the storage and processing tanks of the mobile refuse vehicle shown in FIG. 1.

FIG. 4 is a schematic top view of the storage tanks of the mobile refuse vehicle shown in FIG. 1 labeled inlet and outlets and associated valve arrangements.

FIG. 5 is a schematic rear view of another example mobile refuse vehicle in accordance with the principals of the present disclosure.

FIG. 6 is a schematic side view of a prior art mobile refuse vehicle having a single storage tank.

FIG. 7 is a rear view of the mobile refuse vehicle shown in FIG. 6.

### DETAILED DESCRIPTION

I. General Issues with Mobile Refuse Vehicles

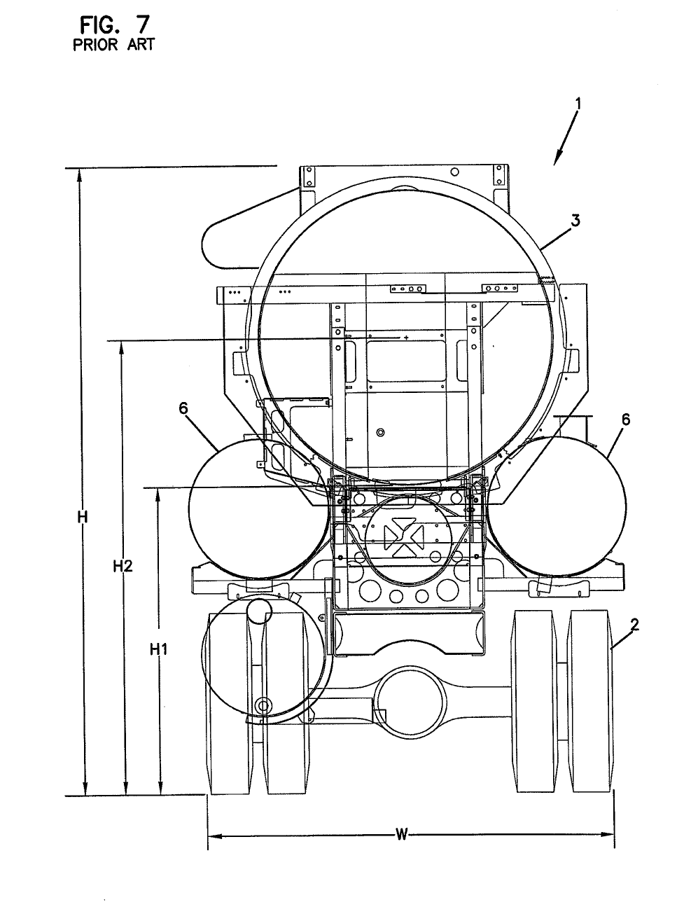

Mobile refuse vehicles generally in accord with the mobile refuse vehicle 1 shown in FIGS. 6 and 7 can be subject to a problem with respect to efficiencies in collecting and processing refuse. In particular, the single storage tank construction of the mobile refuse vehicle 1 requires to a two-step process wherein in a first step the refuse is collected via the refuse collector 4 into the refuse storage tank 3 (e.g., a collection mode), and in a second step collection of refuse is suspended while the stored refuse in the tank 3 is processed using one or more of the processing tanks 6 (e.g., a processing mode). This two-step process requires sequential steps or modes of collecting and processing that is inherently inefficient because only one of collection of refuse or processing of refuse is possible at any one time.

The processing referred to herein can also be characterized as sorting or separating one type of material from another. For example, the collected refuse can include water and material that is suspended or carried by the water. The processing might include removing the material from the water. The processing can also include storing the water in one of the processing tanks 6 and storing the separated material into another of the processing tanks 6. In another example, an air stream carries material as part of the collected refuse, and the processing step includes removing the material from the air stream and storing the material in one of the processing tanks 6. The water and air described in these examples can be re-used by the mobile refuse vehicle 1 as part of further refuse collection.

The mobile refuse vehicle 1 having a single storage tank 3 can also be subject to a problem of unloading the processed material from the storage tank 3. A “dump height” of a mobile refuse vehicle relates in part to the height of the center line of the storage tank 3 relative to a ground surface upon which the mobile refuse vehicle is supported (height H2), and a height of a bottom side of the tank 3 relative to the ground surface (a height H1), seek FIGS. 6 and 7. The greater the height H2 of the tank 3, the higher the center of gravity of the vehicle 1, which can influence stability of the vehicle 1. Increasing the height H1 can improve ease of unloading the tank 3.

The maximum height H of the mobile refuse vehicle 1 is typically limited by regulations. In one example, the height H is no greater than 162 inches. A total width W of the vehicle 1 is also typically limited by regulation. In one example, the width W is no greater than 102 inches. These restrictions on the total height and width of the vehicle 1 can limit the size of the tank 3 and the ability to adjust the heights H1, H2.

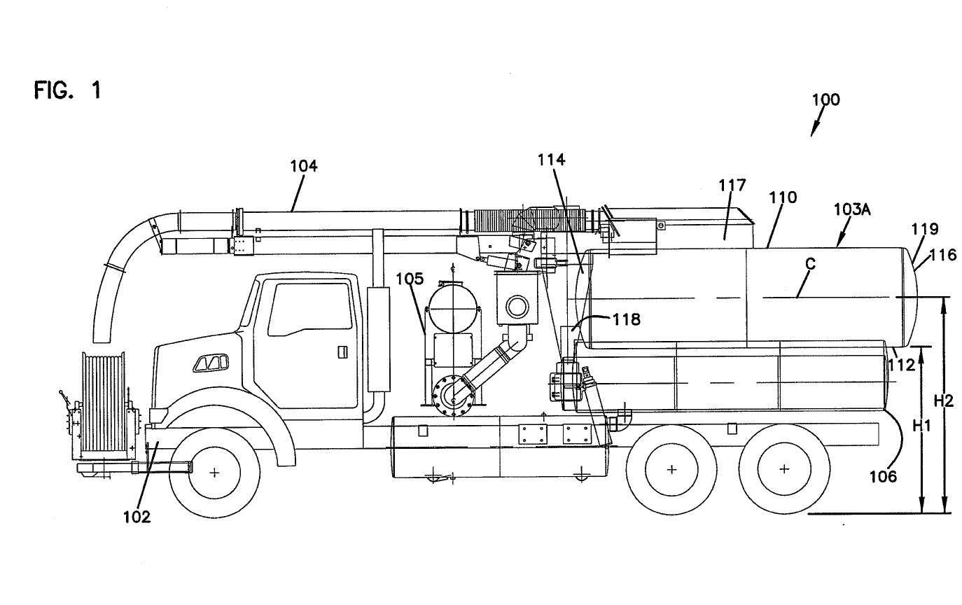

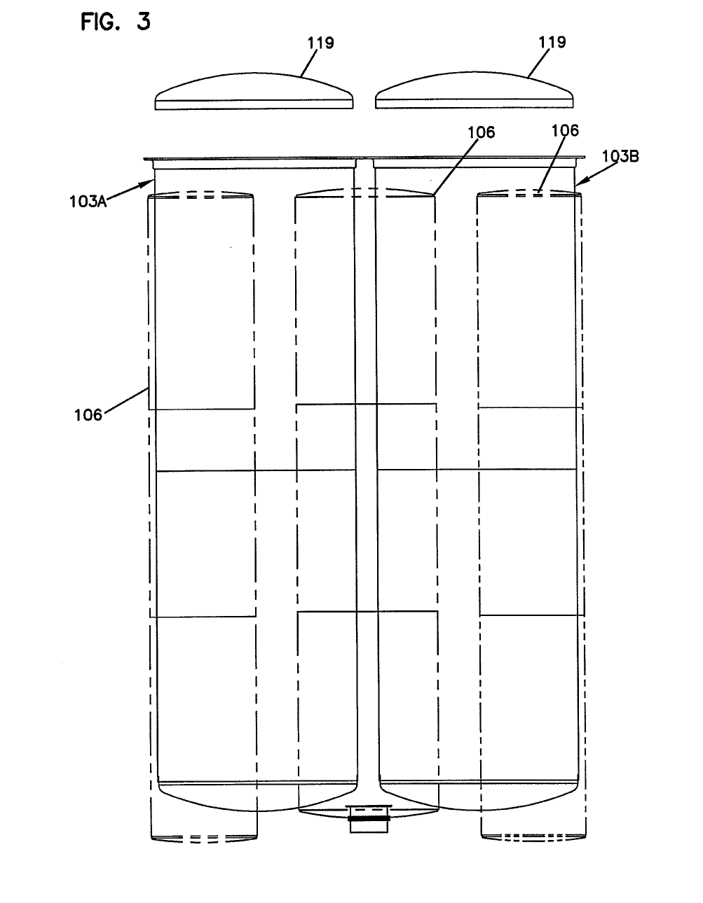

### II. An Improved Mobile Refuse Vehicle: FIGS. 1-5

It is noted that while the techniques described herein are described in the example of the mobile refuse vehicle depicted schematically in FIGS. 1-5, the techniques are applicable to a variety of mobile refuse vehicles and equipment.

FIG. 1 depicts schematically an example mobile refuse vehicle 100. In the embodiment shown, the mobile refuse vehicle 100 includes a truck 102, a refuse storage tank arrangement 103, a refuse collector 104, a vacuum pressure source 105, and a plurality of processing tanks 106. The truck 102 can be any mobile vehicle capable of carrying at least some of the features 103-106.

In the arrangement depicted in FIG. 1, the refuse storage tank arrangement 103 includes first and second storage tanks 103A, 103B. Each of the storage tanks 103A, 103B in the illustrated embodiment includes a top side 110, a bottom side 112, a front end 114, a rear end 116, an inlet 117, an outlet 118, an end cap 119, and a vacuum port 122. The inlet 117 is depicted in FIG. 1 positioned at the top side 110. Positioning the inlet 117 at or near the top side 110 can maximize the input of content into the tank without that content exiting out of the inlet 117. The outlet 118 is depicted in FIG. 1 positioned at the bottom side 112. Positioning the outlet 118 at or near the bottom side 112 can improve removal of as much of the contents of the tank under atmospheric pressure conditions. Other arrangements for the inlet 117 and outlet 118 are possible.

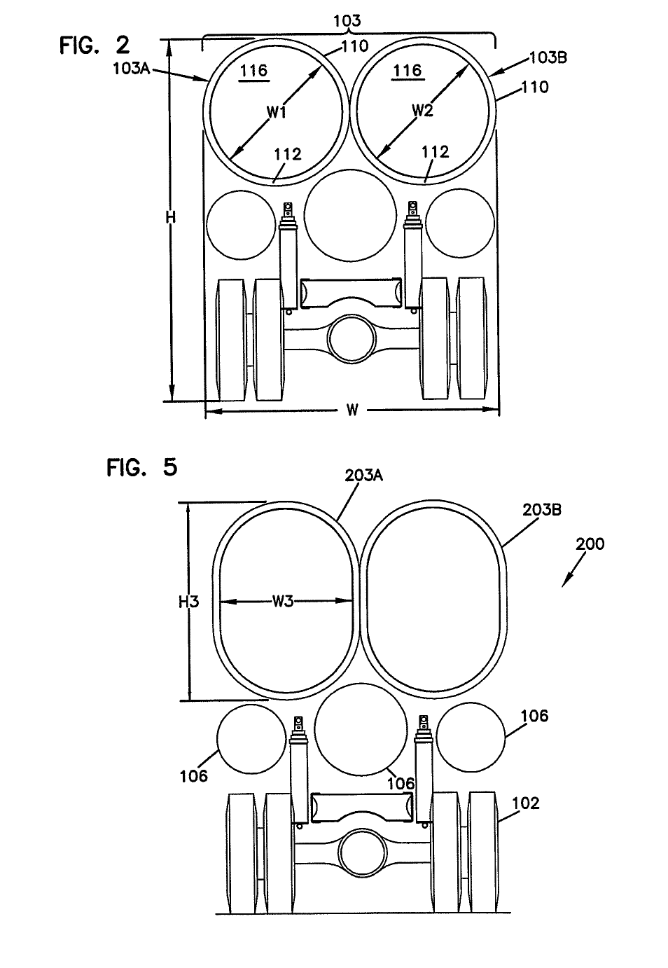

The first and second storage tanks 103A, 103B have a dump height H1 measured to the bottom side 112, and a tank center height H2 measured to a center line C. Each of the tanks 103A, 103B also has a tank width W1 measured horizontally. In a tank configuration having a circular cross-section such as illustrated in FIG. 2, the width W1 of each tank is the same as a height (measured vertically) of the tank. Typically, the widths W1 of each tank when added together is substantially equal to the total width W of the mobile refuse vehicle 100. Further, the dump height H1 when added to the tank height is typically no greater than the total height H of the mobile refuse vehicle 100.

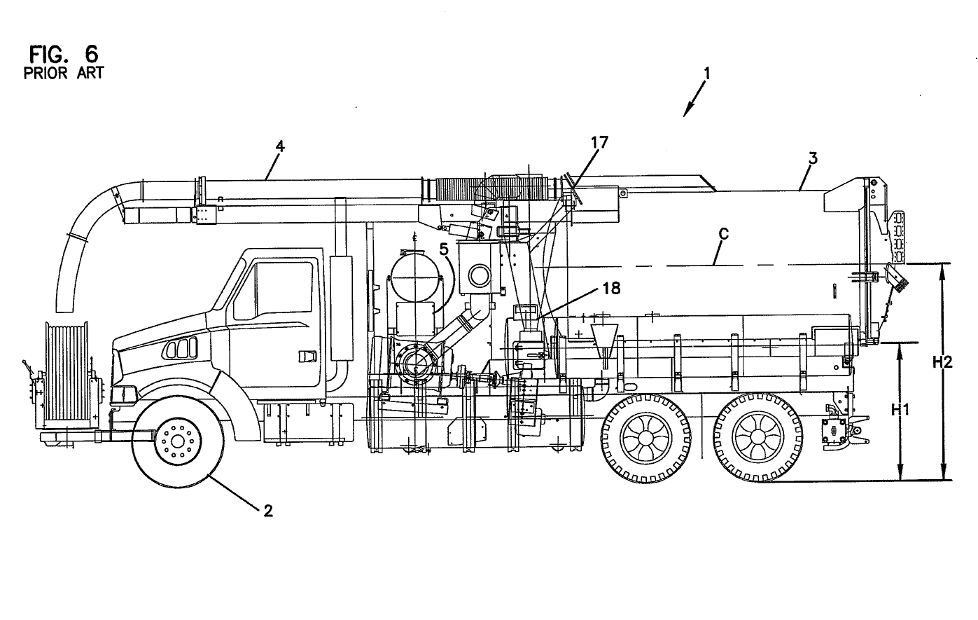

The storage tanks 103A, 103B can have other cross-sectional shapes besides the generally circular shape shown in FIG. 2. For example, FIG. 5 illustrates another example mobile refuse vehicle 200 that includes first and second storage tanks 203a, 203b that have a height H3 that is greater than a width W3. This oblong or oval cross-sectional shape for the tanks 203a, 203b can provide increased volume capacity of the storage tanks for a given total width W and total height H for the mobile refuse vehicle 200. Other tank cross-sectional shapes such as, for example, rectangular, polygonal, D-shaped, or L-shaped can be used. Further, it is possible that the first and second storage tanks can have different cross-sectional shapes (i.e., one storage tank having a generally circular shape and the other tank having an oval shape (e.g., the shape of tank 203a)) and sizes.

While two storage tanks are depicted in FIGS. 1-5, it is possible in other arrangements to provide three or more storage tanks. In some arrangements using multiple storage tanks can provide more efficient use of space within the total height H and width W limitations for a mobile refuse vehicle as compared to a single storage tank (e.g., the single storage tank configuration described with reference to mobile refuse vehicle 1). Further, the use of two or more storage tanks can increase the dump height H1 while maintaining the same or lower center height H2 as compared to a single tank configuration. Providing two or more storage tanks, providing storage tanks with different cross-sectional shapes and sizes, and providing three or more storage tanks are among some of the ways to customize and optimize features such as, for example, a desired dump height H1, a tank center height H2, a center of gravity for the storage tank arrangement, and a total volume capacity of the storage tank arrangement for a given mobile refuse vehicle.

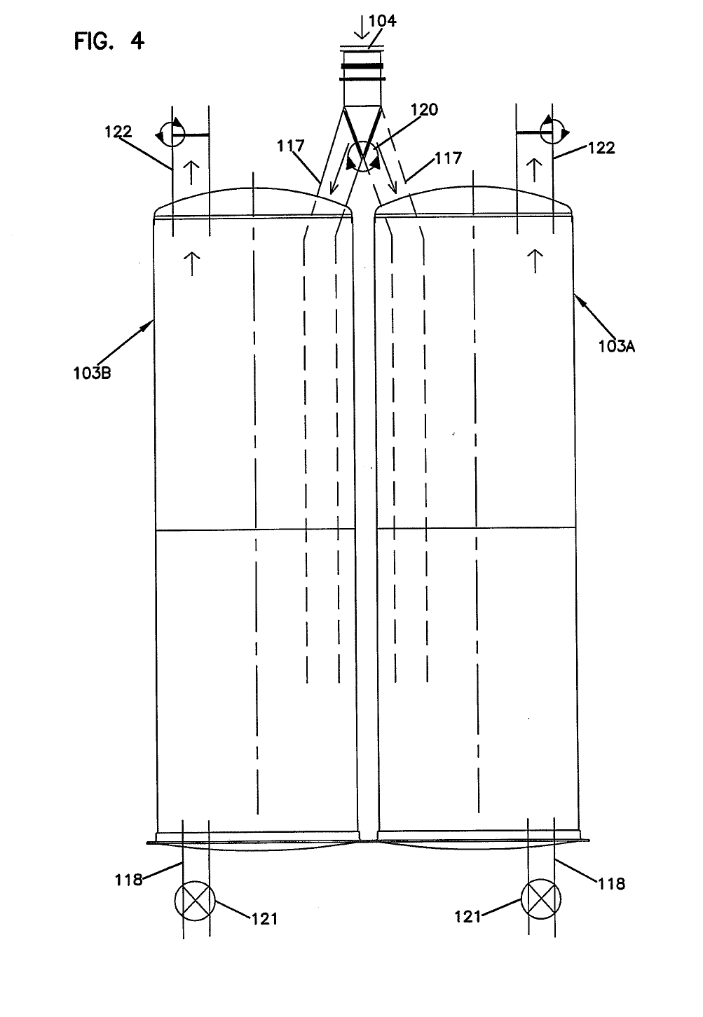

The mobile refuse vehicle 100 can also include an inlet valve arrangement 120 and an outlet valve arrangement 121. FIG. 4 depicts schematically the refuse collector 104 operably coupled to the inlet 117 of each of the storage tanks 103A, 103B via the inlet valve arrangement 120. The inlet valve arrangement 120 can be constructed to selectively provide flow communication from the refuse collector 104 to each of the tanks 103A, 103B. The inlet valve arrangement 120 can help control the flow of refuse collected by the refuse collector 104 into one or the other of the storage tanks 103A, 103B.

In one example, the inlet valve arrangement 120 includes a 3-way valve wherein the inlet 117 of one storage tank is closed while the inlet to the other storage tank is open such that only one of the inlets 117 is open at any given time. Alternatively, the inlet valve arrangement 120 can include a plurality of valve members that are actuated between open and closed states such that either or both of the inlets 117 can be opened or closed at any given time.

The outlet valve arrangement 121 is arranged to control opening and closing of the outlets 118 of each of the storage tanks 103A, 103B. The outlets 118 can be coupled in flow communication with processing equipment such as the processing tanks 106, or can be coupled to an output device such as a hose to remove the contents of the storage tanks 103A, 103B. The outlets 118 can be described as decant openings that are associated with a decant valve arrangements.

In one arrangement, the outlet valve arrangement 121 includes a 3-way valve that is coupled to the outlet 118 of each of the storage tanks 103A, 103B. The 3-way valve can also be coupled in flow communication with a processing system that includes, for example, the processing tanks 106. This example 3-way valve could be configured to maintain one of the outlets 118 in a closed state while the other of the outlets 118 is in an open state.

Other outlet valve arrangements are possible, such as an arrangement that includes a plurality of valve members with at least one valve member associated with each outlet 118. The plurality of valve members can provide concurrent opening of the outlets 118, concurrent closing of the outlets 118, or sequential opening and closing of the outlets 118 such that only one outlet can be closed or one outlet can be open at a given time.

The mobile refuse vehicle 100 can also include a vacuum pressure arrangement 122. The vacuum pressure arrangement 122 can be operably interposed between each of the storage tanks 103A, 103B and the vacuum pressure source 105. In one example, the vacuum pressure arrangement 122 includes a 3-way valve wherein one of the storage tanks 103A, 103B can be exposed to a vacuum pressure condition while the other of the storage tanks can be maintained at atmospheric pressure. In other examples, the vacuum pressure arrangement 122 can include a plurality of valve members with at least one valve member associated with each of the storage tanks 103A, 103B. The valve members of the decant valve arrangement 122 can be separately controlled to selectively apply a vacuum pressure condition to each of the first and second storage tanks 103A, 103B.

Another aspect to the present disclosure is directed to a method of operating the mobile refuse vehicle 100 to collect and process refuse. Other aspects of the present disclosure are directed to a control system for controlling the sequence of states of operation associated with each of the storage tanks 103A, 103B.

According to one example method of operation, the mobile refuse vehicle 100 is operated in a collection mode to collected refuse into a first of the storage tanks, while the second of the storage tanks 103A, 103B is set in a processing mode wherein refuse collected therein is processed. In the collection mode, the first storage tank is operated with the inlet 117 in an open state, the outlet 118 in a closed state, and the first storage tank exposed to a vacuum pressure condition such that refuse collected by the refuse collector 104 can be transferred into and maintained within the first storage tank. The second storage tank, which is in the processing mode, is operated with the inlet 117 in a closed state and the outlet 118 in an open state, such that any refuse stored in that storage tank can be removed and processed. The vacuum pressure condition is typically not applied to the storage tank that is in the processing mode.

Each of the storage tanks can be alternated between the collection mode and the processing mode. Alternating between the collecting and processing modes can be determined based on when the storage tank in the collection mode reaches a predetermined fill state, or when the storage tank in the processing mode is emptied to a predetermined empty state. Other determining factors can be used as the basis for when either one of these storage tanks is switched between the collecting mode and the processing mode.

It is also possible to provide one or both of the storage tanks in a rest mode wherein neither collection nor processing occurs. For example, when the mobile refuse vehicle 100 is first placed in use and both of the storage tanks are empty of refuse, a first of the storage tanks can be placed in the collection mode while the second storage tank remains in a rest mode until the first storage tank is filled to a predetermined level, at which point the second storage tank is placed in the collection mode and the first storage tank is placed in the processing mode. Other situations exist in which one or both of the storage tanks can be placed in the rest mode such as when the mobile refuse vehicle is not in use.

Switching between the collection, processing and rest modes can be made automatic. The mobile refuse vehicle 100 can include a plurality of sensors, metering devices, control devices and other equipment that assess when switching between any of the given collection, processing and rest modes is needed and then carrying out the switching automatically or manually. Alternatively, switching between the collection, processing and rest modes can be manually determined and carried out manually by an operator.

An aspect of the present disclosure relates to a method of operating a mobile refuse vehicle, wherein the mobile refuse vehicle includes first and second refuse storage tanks, a refuse collector, and a vacuum pressure source operably connected to the first and second storage tanks. The first and second storage tanks each include an inlet and an outlet. The inlet is operably connected to the refuse collector. The method can include alternating between a first operational mode in which refuse is collected by the refuse collector into the first storage tank through the inlet of the first storage tank under a vacuum pressure condition while removing refuse from the second storage tank through that second storage tank, and a second operational mode in which refuse is collected by the refuse collector into the second storage tank through the inlet of the second storage tank under a vacuum pressure condition while removing refuse from the first storage tank through the outlet of the first storage tank. The first operational mode can include opening the inlet and closing the outlet of the first storage tank, and opening the outlet and closing the inlet of the second storage tank. The second operational mode can include opening the inlet and closing the outlet of the second storage tank, and closing the outlet of the second storage tank, and opening the outlet and closing the inlet of the first storage tank.

Another aspect of the present disclosure relates to a method of operating mobile refuse vehicles that includes first and second refuse storage tanks, a refuse collector, and a vacuum pressure source operably connected to the first and second storage tanks. The first and second storage tanks each include an inlet operably connected to the refuse collector and an outlet. The method can include creating a first operational mode by opening the outlet and closing the inlet of the second storage tank, closing the outlet and opening the inlet of the first storage tank, and creating a vacuum pressure condition in the first storage tank with the vacuum pressure source. The method can also include collecting refuse through the refuse collector into the first storage tank, removing refuse from the second storage tank through the outlet of the second storage tank during the step of collecting refuse into the storage tank, followed by creating a second operational mode. The second operational mode includes closing the outlet and opening the inlet of the second storage tank, opening the outlet and closing the inlet of the first storage tank, and creating a vacuum pressure condition in the second storage tank with the vacuum pressure source. The method can further include collecting refuse through the refuse collector into the second storage tank and removing refuse from the first storage tank through the outlet of the first storage tank during the step of collecting refuse into the second storage tank.

A further aspect of the present disclosure relates to a mobile refuse vehicle that includes a vehicle, a first storage tank, a second storage tank, a refuse collector, and a vacuum pressure source. The first storage tank includes a first inlet and a first outlet. The second storage tank includes a second inlet and a second outlet. The refuse collector is operably connected in fluid communication with the first and second storage tanks via the first and second inlets. The vacuum pressure source is operably connected to the first and second storage tanks to selectively provide a vacuum pressure condition in the first storage tank or the second storage tank to fill the first or second storage tank with refuse using the refuse collector while refuse is being emptied from the other of the first or second storage tanks.

The first and second storage tanks can be positioned laterally adjacent to each other. In some arrangements, at least a portion of each of the first and second storage tanks are arranged in the same vertical plane. The first and second storage tanks can be arranged on separate halves of the refuse collection vehicle. The vehicle can be divided in halve by a central line that extends from a front end to a rear end of the vehicle and bisects the vehicle between opposing sides of the vehicle. Alternatively, a portion of one of the storage tanks is positioned on one half of the vehicle and a portion of the other of the storage tanks is positioned on the other half of the vehicle.

The preceding embodiments are intended to illustrate without limitation the utility and scope of the present disclosure. Those skilled in the art will readily recognize various modifications and changes that may be made to the embodiments described above without departing from the true spirit and scope of the disclosure.

We claim:

1. A method of operating a mobile refuse vehicle, the mobile refuse vehicle including first and second refuse storage tanks, a refuse collector, and a vacuum pressure source operably connected to the first and second storage tanks, the first and second storage tanks each including an inlet and an outlet, the inlet being operably connected to the refuse collector, the method including alternating between:
(a) a first operation mode in which refuse is collected by the refuse collector into the first storage tank through the inlet of the first storage tank under a vacuum pressure condition while removing refuse from the second storage tank through the outlet of the second storage tank; and
(b) a second operation mode in which refuse is collected by the refuse collector into the second storage tank through the inlet of the second storage tank under a vacuum pressure condition while removing refuse from the first storage tank through the outlet of the first storage tank.

2. A method according to claim 1, wherein the first operational mode includes opening the inlet and closing the outlet of the first storage tank, and opening the outlet and closing the inlet of the second storage tank.

3. A method according to claim 2, wherein the second operational mode includes opening the inlet and closing the outlet of the second storage tank, and opening the outlet and closing the inlet of the first storage tank.

4. A method according to claim 1, wherein the mobile refuse vehicle further includes an inlet valve arrangement operably coupled to the refuse collector and to the inlets of the first and second storage tanks, and alternating between the first and second operation modes include adjusting the inlet valve arrangement to open one of the inlets and close the other of the inlets.

5. The method according to claim 4, wherein the mobile refuse vehicle further includes an outlet valve arrangement operably coupled to the outlets of the first and second storage tanks, and alternating between the first and second operation modes include adjusting the outlet valve arrangement to open one of the outlets and close the other of the outlets.

6. The method according to claim 1, further comprising processing the refuse removed from the first or second storage tank, wherein processing includes separate a waste material from a carrier material.

7. The method of claim 1, wherein removing refuse from the first and second refuse storage tanks includes applying an atmospheric pressure condition to the storage tank from which refuse is being removed.

8. The method of claim 1, wherein each of the first and second refuse storage tanks includes a vacuum port, and the vacuum pressure condition is applied at the vacuum port.

9. A method of operating a mobile refuse vehicle, the mobile refuse vehicle including first and second refuse storage tanks, a refuse collector, and a vacuum pressure source operably connected to the first and second storage tanks, the first and second storage tanks each include an inlet operably connected to the refuse collector and an outlet, the method including:
(a) initiating a first operation mode, the first operation mode including:
(i) opening the outlet and closing the inlet of the second storage tank;
(ii) closing the outlet and opening the inlet of the first storage tank;
(iii) creating a vacuum pressure condition in the first storage tank with the vacuum pressure source;
(b) collecting refuse through the refuse collector into the first storage tank after initiating the first operation mode;
(c) removing refuse from the second storage tank through the outlet of the second storage tank during the step of collecting refuse into the first storage tank;
(d) initiating a second operation mode after initiating the first operation mode, the second operation mode including:
(i) closing the outlet and opening the inlet of the second storage tank;
(ii) opening the outlet and closing the inlet of the first storage tank;
(iii) creating a vacuum pressure condition in the second storage tank with the vacuum pressure source;
(e) collecting refuse through the refuse collector into the second storage tank after initiating the second operation mode; and
(f) removing refuse from the first storage tank through the outlet of the first storage tank during the step of collecting refuse into the second storage tank.

10. A method according to claim 9, wherein the steps of removing refuse from the second storage tank and removing refuse from the first storage tank include exposing the first and second storage tanks to atmospheric pressure.

11. A method according to claim 9, wherein the mobile refuse vehicle further includes an inlet valve arrangement operably coupled to the refuse collector and to the inlets of the first and second storage tanks, the step of initiating a first operation mode includes adjusting the inlet valve arrangement to close the inlet of the second storage tank and open the inlet of the first storage tank, and the step of creating a second operation mode includes adjusting the inlet valve arrangement to open the inlet of the second storage tank and close the inlet of the first storage tank.

12. A method according to claim 9, wherein the mobile refuse vehicle further includes an outlet valve arrangement operably coupled to the outlets of the first and second storage tanks, the step of initiating a first operation mode includes adjusting the outlet valve arrangement to close the outlet of the first storage tank and open the outlet of the second storage tank, and the step of creating a second operation mode includes adjusting the inlet valve arrangement to open the outlet of the first storage tank and close the outlet of the second storage tank.

13. A method according to claim 9, wherein the first and second storage tanks each include a vacuum port, and the step of initiating a first operation mode further includes opening the vacuum port of the first storage tank prior to the step of creating a vacuum pressure condition in the first storage tank with the vacuum pressure source, and the step of initiating a second operation mode further includes opening the vacuum port of the second storage tank prior to the step of creating a vacuum pressure condition in the second storage tank with the vacuum pressure source.

14. A mobile refuse vehicle comprising:
(a) a first storage tank having a first inlet and a first outlet;
(b) a second storage tank having a second inlet and a second outlet;
(c) a refuse collector operably connected in fluid communication with the first and second storage tanks via the first and second inlets; and
(d) a vacuum pressure source operably connected to the first and second storage tanks to selectively provide a vacuum pressure condition in the first storage tank or the second storage tank to fill the first or second storage tank with refuse using the refuse collector while refuse is being emptied from the other of the first or second storage tank.

15. A mobile refuse vehicle according to claim 14, further comprising a three-way valve operably coupled to the first and second inlets and the refuse collector, wherein opening the first inlet with the three-way valve concurrently closes the second inlet, and closing the second inlet with the three-way valve concurrently opens the second outlet.

16. A mobile refuse vehicle according to claim 14 wherein the first and second storage tanks are positioned laterally adjacent to each other.

17. A mobile refuse vehicle according to claim 16 wherein at least one of the first and second storage tanks includes an oval cross-section.
